(19) United States
(12) Patent Application Publication
(10) Pub. No.: US 2015/0169882 A1
(43) Pub. Date: Jun. 18, 2015

(54) SYSTEM AND METHOD FOR PROVIDING GRAPHICAL DYNAMIC USER AUTHENTICATION AND DEVICE ACCESS

(71) Applicant: Infosys Limited, Bangalore (IN)

(72) Inventors: Ashutosh Saxena, Hyderabad (IN); Sravan Kumar Rondla, Hyderabad (IN)

(73) Assignee: Infosys Limited, Bangalore (IN)

(21) Appl. No.: 14/493,633

(22) Filed: Sep. 23, 2014

(30) Foreign Application Priority Data
Dec. 17, 2013 (IN) 5878/CHE/2013

(51) Int. Cl. G06F 21/60; G06N 5/02

(52) U.S. Cl. CPC G06F 21/604; G06N 5/025

(57) ABSTRACT

The technique relates to a system and method for providing graphical dynamic user authentication and device access. The method involves maintaining a database in an electronic device having plurality of entities in a plurality of fields then prompting at least one user to generate at least one action rule at the time of first usage of the electronic device by selecting an entity among the plurality of entities from one or more of the plurality of fields thereafter storing the at least one action rule in a repository of the electronic device then prompting the at least one user to apply the at least one action rule at the time of unlocking and finally granting the at least one user an access to the electronic device if the at least one applied action successfully passes the rule identical to the at least one stored action rule for the user.

### FIELD

The field relates generally to providing user authentication and device access, and in particular, to a system and method for providing graphical dynamic user authentication and device access.

### BACKGROUND

The use of mobile or electronic devices has become widespread these days. These devices provide the user with a variety of functionalities ranging from wireless telephonic communication, Internet access, online financial transactions, online shopping, etc. Thus, today's mobile devices help the users with all features that were traditionally possible with only non-mobile computing systems. Examples of such mobile electronic devices include: mobile devices, smart phones, watches, glasses, cellular phones, personal digital assistants (PDAs), digital cameras, mobile computers and tablets, etc. With such an increased prominence, these electronic devices are being used for a varied range of personal activities. Most of these activities like mobile banking, e-commerce etc. require the usage of sensitive information which is often stored in the user's personal electronic devices. These devices also carry significant personal details of the users like key contacts, e-mail messages, photos, and videos etc. which carry great personal value. However, unfortunately, these mobile devices are quite susceptible to loss, theft and unauthorized usage. These devices often carry private, confidential and/or difficult to replace data, whose unauthorized use/misuse may lead to unpleasant consequences.

The existing methods for authenticating users onto traditional electronic device may involve typing a unique password and/or unique PIN number onto the mobile or electronic device keypad. However, this involves the user to remember complex character/alpha-numeric passwords which may be required to be changed periodically making it still hard an exercise for the user to remember.

Another popular hand-held device keypad lock and unlock mechanism is triggered by pressing a specific key for longer than a predetermined period of time, for example, pressing the star key (*) for more than 3 seconds.

The mobile devices with touch sensitive interface have become prevalent. The user authentication methods developed for these devices take into consideration the touch sensitive input devices into account. These techniques require the user to draw specific patterns on the screen and the users then are authenticated based on the similarity of this pattern with the stored pattern. The problem with such kind of approaches is that, any person, who has a chance to peep at the pattern, can easily draw the same pattern in the absence of the genuine owner and/or user of the device. This kind of misuse is popularly referred to as “Shoulder Surfing”. Even when a user of the device keeps a complex pattern, like his signature, a malicious person can video record the pattern and imitate the same in the absence of the user. Thus, security of the mobile device may be breached resulting in theft and/or misappropriation of the confidential information that may be stored in the mobile device.

Another problem with existing user authentication technique is that they are static in nature, however users are provided the option periodically or otherwise to change the password and/or the pattern to access the device but not in the way that they need to present different pattern every time to access/unlock.

In view of forgoing discussion, there is a need for providing dynamic user authentication technique and the consequent granting or denying of resources and services access in order to prevent unauthorized usage of electronic devices.

### SUMMARY

The disclosed technologies can overcome the limitation mentioned above by providing graphical dynamic user authentication and device access. This is being accomplished by providing a system and method which creates the graphical dynamic pattern for user authentication on fly and dynamic patterns generation and application based access reduces the threat of shoulder surfing to a greater extent.

According to the present embodiment, a method for providing graphical dynamic user authentication and device access is disclosed. The method involves maintaining a database in an electronic device, wherein the database comprises a plurality of entities in a plurality of fields then prompting at least one user to generate at least one action rule at the time of first usage of the electronic device by selecting an entity among the plurality of entities from one or more of the plurality of fields thereafter storing the at least one action rule in a repository of the electronic device then prompting the at least one user to apply the at least one action rule at the time of unlocking and finally granting the at least one user an access to the electronic device if the at least one applied action successfully passes the rule identical to the at least one stored action rule for the user.

In an additional embodiment, a system for providing graphical dynamic user authentication and device access is disclosed. The system includes a database maintenance component, an action rule generation component, an action rule storage component, a user prompt component and an access grant component. The database maintenance component configured to maintain a database in an electronic device, wherein the database comprises a plurality of entities in a plurality of fields. The action rule generation component configured to prompt at least one user to generate at least one action rule at the time of first usage of the electronic device by selecting an entity among the plurality of entities from each of the plurality of fields. The action rule storage component configured to store the at least one action rule in a repository of the electronic device. The user prompt component configured to prompt the at least one user to apply the at least one action rule at the time of unlocking. The access grant component configured to grant the at least one user, an access to the electronic device if the at least one applied action successfully passes the rule identical to the at least one stored action rule for the user.

In another embodiment, a non-transitory computer readable medium for providing dynamic user authentication and device access is disclosed. This involves a non-transitory computer readable medium having stored thereon instructions for providing graphical dynamic user authentication and device access. The computer program code is adapted to maintaining a database in an electronic device, wherein the database comprises a plurality of entities in a plurality of fields then prompting at least one user to generate at least one action rule at the time of first usage of the electronic device by selecting an entity among the plurality of entities from one or more of the plurality of fields thereafter storing the at least one action rule in a repository of the electronic device then prompting the at least one user to apply the at least one action rule at the time of unlocking and finally granting the at least one user an access to the electronic device if the at least one applied action successfully passes the rule identical to the at least one stored action rule for the user.

### DRAWINGS

Various embodiments of the invention will, hereinafter, be described in conjunction with the appended drawings provided to illustrate, and not to limit the invention, wherein like designations denote like elements, and in which:

FIG. 1 is a computer architecture diagram illustrating a computing system capable of implementing the embodiments presented herein.

FIG. 2 is a flowchart, illustrating a method for providing graphical dynamic user authentication and device access, in accordance with an embodiment of the present technique.

FIG. 3 is depicts an exemplary diagram illustrating plurality of entities in a plurality of fields and generation of action rule, in accordance with an embodiment of the present technique.

FIG. 4 is a block diagram illustrating a system for illustrating a system for providing dynamic user authentication and device access, in accordance with an embodiment of the present technique.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

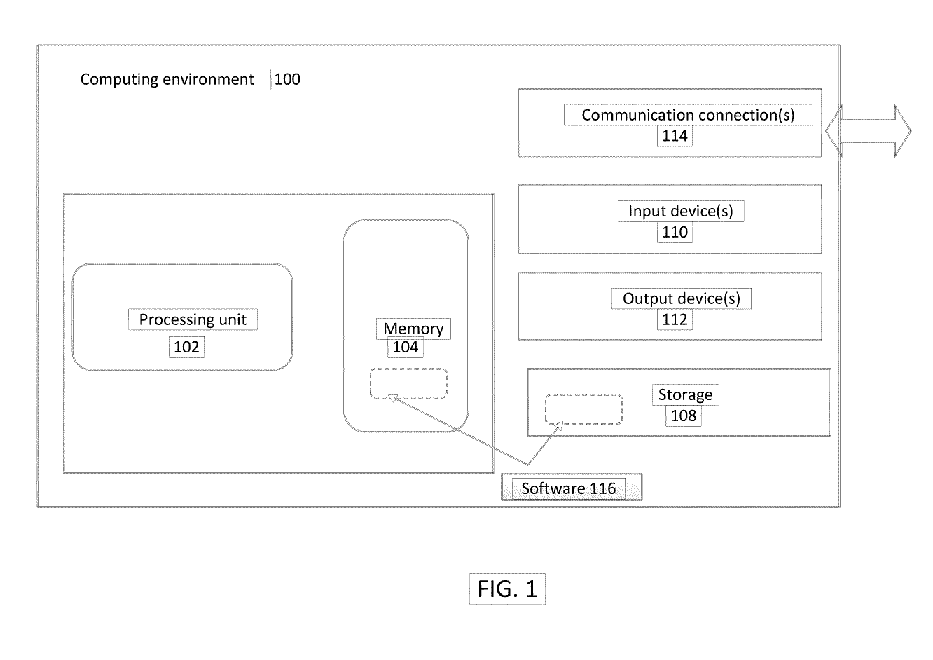

FIG. 1 illustrates a generalized example of a suitable computing environment 100 in which all embodiments, techniques, and technologies of this invention may be implemented. The computing environment 100 is not intended to suggest any limitation as to scope of use or functionality of the technology, as the technology may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the service level management technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like.

With reference to FIG. 1, the computing environment 100 includes at least one central processing unit 102 and memory 104. The central processing unit 102 executes computer-executable instructions. In a multi-processing system, multiple processing units execute computer-executable instructions to increase processing power and as such, multiple processors can be running simultaneously. The memory 104 may be volatile memory (e.g., registers, cache, RAM), non-volatile memory (e.g., ROM, EEPROM, flash memory, etc.), or some combination of the two. The memory 104 stores software 116 that can implement the technologies described herein. A computing environment may have additional features. For example, the computing environment 100 includes storage 108, one or more input devices 110, one or more output devices 112, and one or more communication connections 114. An interconnection mechanism (not shown) such as a bus, a controller, or a network, interconnects the components of the computing environment 100. Typically, operating system software (not shown) provides an operating environment for other software executing in the computing environment 100, and coordinates activities of the components of the computing environment 100.

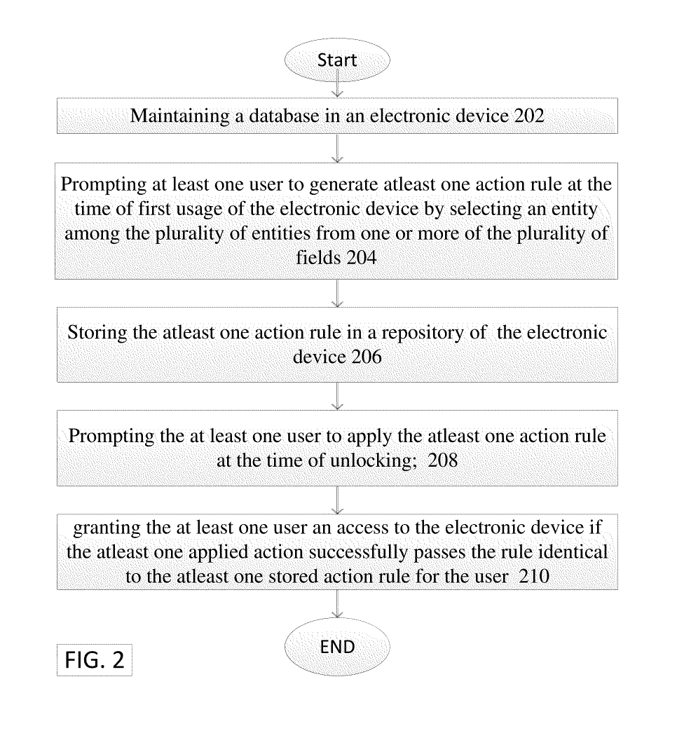

FIG. 2 is a flowchart, illustrating a method for providing dynamic user authentication and device access, in accordance with an embodiment of the present technique. A database in maintained in an electronic device wherein the database comprises a plurality of entities in a plurality of fields 202. The user is prompted to generate at least one action rule at the time of first usage of the electronic device by selecting an entity among the plurality of entities from one or more of the plurality of fields 204. Then action rule is stored in a repository of the electronic device 206. Thereafter, the user is prompted to apply to apply the at least one action rule at the time of unlocking 208. And finally an access is granted to the electronic device if the at least one applied action rule is identical to the at least one stored action rule for the user 210. The at least one action rule comprises a rule for drawing or selecting at least one pattern on the display area of the electronic device wherein the at least one pattern is dynamic.

According to another embodiment of the invention, a user is allowed to change the at least one action rule. Also, the method enables the setting of different set of action rules for different users. For instance, an electronic device is accessed by more than one user in such scenario both the user can generate two separate set of action rule in order to get access to a device.

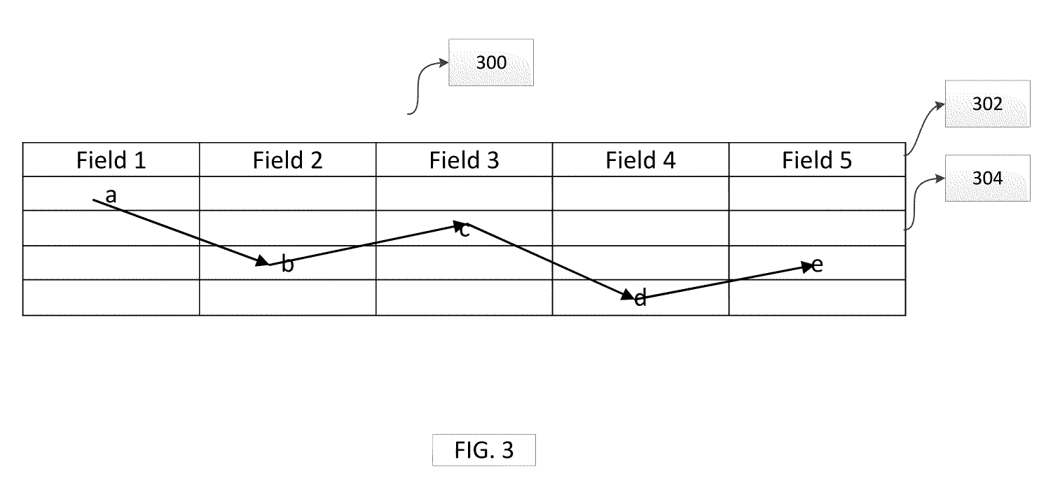

FIG. 3 is depicts an exemplary diagram illustrating plurality of entities in a plurality of fields and generation of action rule, in accordance with an embodiment of the present technique 300. According to an exemplary embodiment of the invention the rows in FIG. 3. represents plurality of fields 302 and the columns represents plurality of entities 304. A rule database is maintained which may be maintained by the manufacturer electronic device. At the time of manufacturing single electronic device plurality of fields and entities may be imported randomly. Alternatively, it may be downloaded from the internet or any authorized repository. The fields are independent of each other hence number of entries in one field may be different from the number of entries in other fields. At first time usage and/or user registration of electronic device a user is prompted to generate at least one action rule by selecting an entity among the plurality of entities from one or more of the plurality of fields 304 and storing the same in a repository of electronic device 306. As shown in FIG. 3. there are five fields and any combination of fields forms a pattern rule. For instance: a-b-c-d-e.

According to an exemplary embodiment of the invention an exemplary action rule which at least one user apply at the time of unlocking for accessing an electronic device is depicted below. According to one embodiment of the invention at least one user is prompted to apply the at least one action rule at the time of unlocking of the electronic device 308 and granting an access to the electronic device if the at least one applied action rule is identical to the at least one stored action rule for the user 310. According to an exemplary embodiment of the invention, an example of rule generation is depicted in TABLE 1.

TABLE 1

| Field 1 | Field 2 | Field 3 |
|---|---|---|
| Select | the red dots | that form a rectangle |
| Join | the blue dots | that form a pentagon |
| Traverse | the left side dots | that lie on a straight line |
| | the dots | that have the least distance |
| | | between them |

The user can generate action rule in any combination. The exemplary patterns based on the above table may be:
a. Select the red dots that form a triangle
b. Select the left side dots that lie on a straight line
c. Select the left side dots that have the least distance between them.

For instance, at the time of unlocking of electronic device the pattern which may come randomly could be a. i.e. select the red dots that form a rectangle. Similarly, next time while unlocking of device the next pattern could be b i.e select the left side dots that lie on a straight line. At each time of unlocking of device the pattern would be generated randomly with different combinations and access to the electronic device would be granted if the at least one applied action rule is identical to the at least one stored action rule for the user.

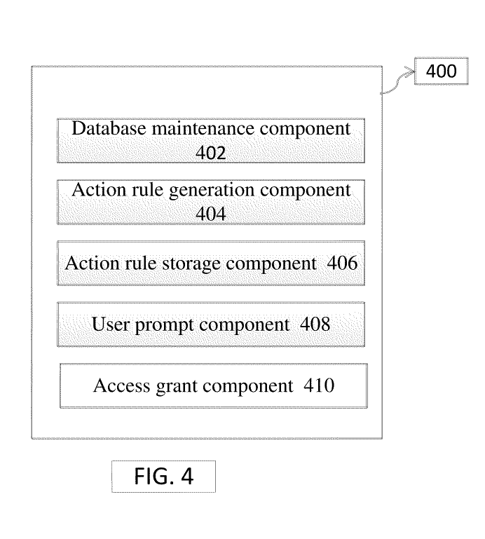

FIG. 4 is a block diagram illustrating a system for illustrating a system for providing graphical dynamic user authentication and device access, in accordance with an embodiment of the present technique. More particularly system includes a database maintenance component 402, an action rule generation component 404, an action rule storage component 406, a user prompt component 408 and an access grant component 410. The database maintenance component configured to maintain a database in an electronic device, wherein the database comprises a plurality of entities in a plurality of fields. The action rule generation component configured to prompt at least one user to generate at least one action rule at the time of first usage and/or registering the user of the electronic device by selecting an entity among the plurality of entities from each of the plurality of fields. The action rule storage component configured to store the at least one action rule in a repository of the electronic device. The user prompt component configured to prompt the at least one user to apply the at least one action rule at the time of unlocking. The access grant component configured to grant the at least one user, an access to the electronic device if the at least one applied action successfully passes the rule identical to the at least one stored action rule for the user.

The above mentioned invention is not limited to touch sensitive screens. It may be adapted to work with non-touch sensitive screens and/or devices.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

We claim:

1. A computer implemented method for providing dynamic user authentication and device access comprising:
maintaining a database in an electronic device, wherein the database comprises a plurality of entities in a plurality of fields;
prompting, by a processor, at least one user to generate at least one action rule at the time of first usage of the electronic device by selecting an entity among the plurality of entities from one or more of the plurality of fields;
storing, by the processor, the at least one action rule in a repository of the electronic device;
prompting, by the processor, the at least one user to apply the at least one action rule at the time of unlocking; and
granting the at least one user, by processor, an access to the electronic device if the at least one applied action rule is identical to the at least one stored action rule for the user.

2. The method as claimed in claim 1, wherein the at least one action rule comprises a rule for drawing or selecting at least one pattern on the display area of the electronic device.

3. The method as claimed in claim 2, wherein the at least one pattern is dynamic.

4. The method as claimed in claim 1 further comprises allowing the at least one user to change the at least one action rule.

5. A system for providing dynamic user authentication and device access comprising:
a processor in operable communication with a processor readable storage medium, the processor readable storage medium containing one or more programming instructions whereby the processor is configured to implement:
a database maintenance component configured to maintain a database in an electronic device, wherein the database comprises a plurality of entities in a plurality of fields;
an action rule generation component configured to prompt at least one user to generate at least one action rule at the time of first usage of the electronic device by selecting an entity among the plurality of entities from each of the plurality of fields;
an action rule storage component configured to store the at least one action rule in a repository of the electronic device;
a user prompt component configured to prompt the at least one user to apply the at least one action rule at the time of unlocking; and
an access grant component configured to grant the at least one user, an access to the electronic device if the at least one applied action rule is identical to the at least one stored action rule.

6. The system as claimed in claim 5, wherein the at least one action rule comprises a rule for drawing or selecting at least one pattern on the display area of the electronic device.

7. The system as claimed in claim 6, wherein the at least one pattern is dynamic.

8. The system as claimed in claim 5 further comprises an action rule change component configured to allow the at least one user to change the at least one action rule.

9. A non-transitory computer readable medium having stored thereon instructions for providing dynamic user authentication and device access comprising machine executable code which when executed by at least one processor, causes the at least one processor to perform steps comprising:
maintaining a database in an electronic device, wherein the database comprises a plurality of entities in a plurality of fields;
prompting at least one user to generate at least one action rule at the time of first usage of the electronic device by selecting an entity among the plurality of entities from each of the plurality of fields;
storing the at least one action rule in a repository of the electronic device;
prompting the at least one user to apply the at least one action rule at the time of unlocking; and
granting the at least one user, an access to the electronic device if the at least one applied action rule is identical to the at least one stored action rule.

10. The non-transitory computer readable media as claimed in claim 9, wherein the at least one action rule comprises a rule for drawing or selecting at least one pattern on the display area of the electronic device.

11. The non-transitory computer readable media as claimed in claim 10, wherein the at least one pattern is dynamic.

12. The non-transitory computer readable media as claimed in claim 9 further comprises allowing the at least one user to change the at least one action rule.
